(19) United States
(12) Patent Application Publication
(10) Pub. No.: US 2015/0093177 A1
(43) Pub. Date: Apr. 2, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventor: Steven E. Morris, Fair Haven, MI (US)

(73) Assignee: GM GLOBAL TECHNOLOGY OPERATIONS LLC, Detroit, MI (US)

(21) Appl. No.: 14/039,614

(22) Filed: Sep. 27, 2013

(51) Int. Cl. B62D 27/02

(52) U.S. Cl. CPC B62D 27/02
USPC 403/13; 264/299; 29/592

(57) ABSTRACT

In one aspect, an elastically averaged alignment system is provided. The alignment system includes a first component having an alignment member, and a second component having an inner wall defining an alignment aperture. The alignment aperture is configured to receive the alignment member to couple the first component and the second component. The alignment member includes at least one retention member configured to engage the second component to facilitate retaining at least a portion of the alignment member within the alignment aperture. The alignment member is an elastically deformable material such that when the alignment member is inserted into the alignment aperture, the alignment member elastically deforms to an elastically averaged final configuration to facilitate aligning and stiffening the first component and the second component in a desired orientation.

### FIELD OF THE INVENTION

The subject invention relates to matable components and, more specifically, to elastically averaged matable components for alignment and retention.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling, and further result in the perception of poor quality.

Further, to align and secure components, the aforementioned male and female alignment features may be employed in combination with separate securing features, such as nuts and bolts, snap/push-in fasteners, plastic rivets, and snap rivets, to name a few, that serve to secure the components to each other. In such an assembly, the mating components are located relative to each other by the alignment features, and are fixed relative to each other by the securing features. Use of separate alignment features and securing features, one for alignment and the other for securement, may limit the effectiveness of each on a given assembly, as the alignment features cannot be employed where the securing features are employed.

Additionally, some components, particularly components made of compliant materials, may not remain mated to another component due to vehicle movement, passage of time, or other factors. As such, the male alignment features may become disengaged from corresponding female alignment features leading to additional noise, vibration, or reduced durability.

### SUMMARY OF THE INVENTION

In one aspect, an elastically averaged alignment system is provided. The alignment system includes a first component having an alignment member, and a second component having an inner wall defining an alignment aperture. The alignment aperture is configured to receive the alignment member to couple the first component and the second component. The alignment member includes at least one retention member configured to engage the second component to facilitate retaining at least a portion of the alignment member within the alignment aperture. The alignment member is an elastically deformable material such that when the alignment member is inserted into the alignment aperture, the alignment member elastically deforms to an elastically averaged final configuration to facilitate aligning and stiffening the first component and the second component in a desired orientation.

In another aspect, a vehicle is provided. The vehicle includes a body and an elastically averaged alignment system integrally arranged with the body. The elastically averaged alignment system includes a first component having an alignment member and a second component having an inner wall defining an alignment aperture. The alignment aperture is configured to receive the alignment member to couple the first component and the second component. The alignment member includes at least one retention member configured to engage the second component to facilitate retaining at least a portion of the alignment member within the alignment aperture, the alignment member being an elastically deformable material such that when the alignment member is inserted into the alignment aperture, the alignment member elastically deforms to an elastically averaged final configuration to facilitate aligning the first component and the second component in a desired orientation.

In yet another aspect, a method of manufacturing an elastically averaged alignment system is provided. The method includes forming a first component having an alignment member, forming a second component having an inner wall defining an alignment aperture configured to receive the alignment member to couple the first and second components, and forming at least one retention member on the alignment member configured to engage the second component to facilitate retaining at least a portion of the alignment member within the alignment aperture. The first component is an elastically deformable material such that when the alignment member is inserted into the alignment aperture, the alignment member elastically deforms to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1A is a perspective view of a disassembled, exemplary elastically averaged alignment system;

FIG. 1B is a plan view of a first component of the elastically averaged alignment system shown in FIG. 1A;

FIG. 2 is a cross-sectional view of the disassembled elastically averaged alignment system shown in FIG. 1 and taken along line 2-2;

FIG. 3 is a cross-sectional view of the elastically averaged alignment system shown in FIGS. 1 and 2 without standoffs and after assembly;

FIG. 4 is a cross-sectional view of an exemplary alignment member positioned within an exemplary mold;

FIG. 5 is a cross-sectional view of the exemplary alignment member shown in FIG. 4 after the mold has been separated;

FIG. 6 is a side view of a vehicle including the elastically averaged alignment system shown in FIGS. 1-3; and

FIG. 7 is a cross-sectional view of another exemplary elastically averaged alignment system that may be used with the vehicle shown in FIG. 6.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment and retention systems, as well as methods for elastically averaged mating assemblies. The alignment and retention systems include retention member(s) that facilitate preventing unintentional disassembly of the elastically averaged mated assemblies, yet allow purposeful disassembly if desired. As such, the alignment and retention systems prevent accidental or premature separation of mated components, thereby maintaining a proper coupling between and desired orientation of two or more components.

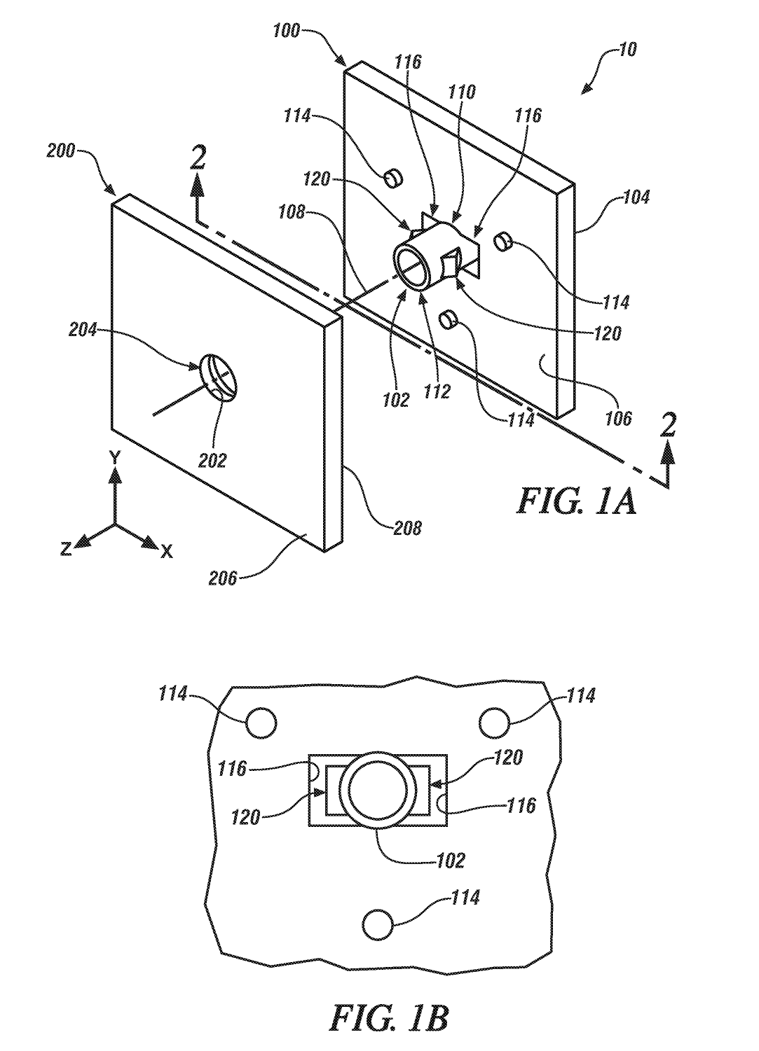

FIGS. 1-3 illustrate an exemplary elastically averaged alignment system 10 that generally includes a first component 100 to be mated to a second component 200 and retained in mated engagement by a retention member 120. First component 100 includes an elastically deformable alignment member 102, and second component 200 includes an inner wall 202 defining an alignment aperture 204. Alignment member 102 and alignment aperture 204 are fixedly disposed on or formed integrally with their respective component 100, 200 for proper alignment and orientation when components 100 and 200 are mated. Although a single alignment member 102 and alignment aperture 204 are illustrated, components 100 and 200 may have any number and combination of corresponding alignment members 102 and alignment apertures 204. Elastically deformable alignment member 102 is configured and disposed to interferingly, deformably, and matingly engage alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable alignment member 102 matingly engages alignment aperture 204 to facilitate a stiff and rigid connection between first component 100 and second component 200, thereby reducing or preventing relative movement therebetween.

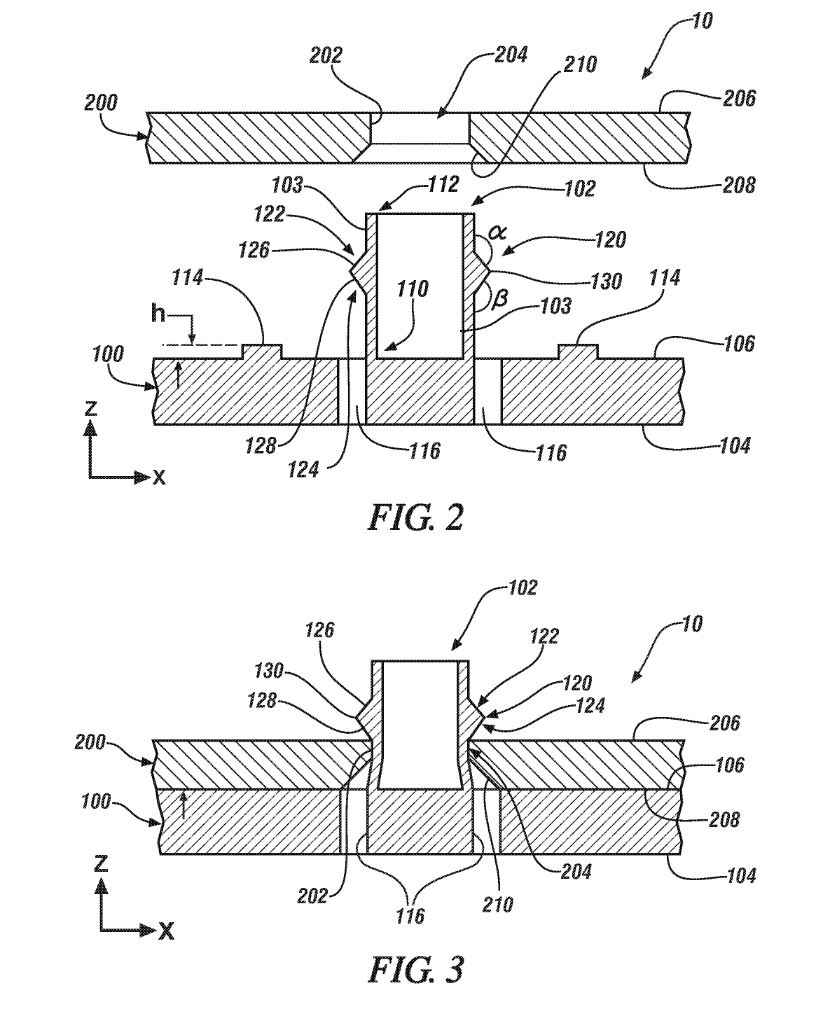

In the exemplary embodiment, first component 100 generally includes an outer face 104 and an inner face 106 from which alignment member 102 extends. Alignment member 102 is a generally circular hollow tube having a central axis 108, a proximal end 110 coupled to inner face 106, and a distal end 112. However, alignment member 102 may have any cross-sectional shape that enables system 10 to function as described herein. First component 100 may optionally include one or more stand-offs 114 (FIGS. 1 and 2) for engaging and supporting second component 200. As shown best in FIGS. 1A and 1B, first component 100 also includes a pair of opposed tool clearance apertures 116 proximal each alignment aperture 102 to facilitate forming first component 100, as is described herein in more detail. In the exemplary embodiment, first component 100 is fabricated from a rigid material such as plastic. However, first component 100 may be fabricated from any suitable material that enables system 10 to function as described herein.

Second component 200 generally includes an outer face 206, and an inner face 208. In the exemplary embodiment, alignment aperture 204 is illustrated as having a generally circular cross-section. Alternatively, alignment aperture 204 may have any shape that enables system 10 to function as described herein. For example, alignment aperture 204 may be an elongated slot (e.g., similar to the shape of elastic tube alignment system described in co-pending U.S. patent application Ser. No. 13/187,675 and particularly illustrated in FIG. 13 of the same). In the exemplary embodiment, second component 200 is fabricated from a rigid material such as sheet metal. However, second component 200 may be fabricated from any suitable material that enables system 10 to function as described herein.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment. Alternatively, first component 100 may be an intermediate component located between second component support substructure 200 and a decorative trim component 400 such as a vehicle grille (see FIG. 7).

To provide an arrangement where elastically deformable alignment member 102 is configured and disposed to interferingly, deformably and matingly engage alignment aperture 204, the diameter of alignment aperture 204 is less than the diameter of alignment member 102, which necessarily creates a purposeful interference fit between the elastically deformable alignment member 102 and alignment aperture 204. Further, second component 200 may include a chamfer 210 to facilitate insertion of alignment member 102. As such, when inserted into alignment aperture 204, portions of the elastically deformable alignment member 102 elastically deform to an elastically averaged final configuration that aligns alignment member 102 with the alignment aperture 204 in four planar orthogonal directions (the +/−x-direction and the +/−y-direction). Where alignment aperture 204 is an elongated slot (not shown), alignment member 102 is aligned in two planar orthogonal directions (the +/−x-direction or the +/−y-direction).

Alignment member 102 includes retention member 120 that facilitates retention of alignment member 102 within alignment aperture 204 in the +/−z direction. As shown in FIGS. 1-3, retention member 120 includes a first angled portion 122 and a second angled portion 124 each extending angularly from alignment member distal end 112. First angled portion 122 defines an insertion face 126 configured to engage inner wall 202 and/or chamfer 210 during insertion of alignment member 102 within alignment aperture 204. In the exemplary embodiment, insertion face 126 extends from an alignment member outer wall 103 at an angle “α”, which may be variably designed such that a predetermined force will be required to insert alignment member 102. For example, as angle “α” is increased, the force required for alignment member insertion is reduced, and vice versa. Similarly, second angled portion 124 defines a retention face 128 configured to engage outer surface 206 and/or inner wall 202 following insertion and during removal of alignment member 102 from within alignment aperture 204. In the exemplary embodiment, retention face 128 extends from alignment member outer wall 103 at an angle “β”, which is variably designed such that a predetermined force will be required to remove alignment member 102 from alignment aperture 204. For example, as angle “β” is increased, the force requirement for alignment member removal is reduced, and vice versa. Moreover, angle “β” may be designed such that retention face 128 prevents removal of alignment member 102 alignment aperture 204 after insertion therein. For example, “β” may be approximately 90° such that retention face 128 is substantially parallel to outer face 206 after insertion.

In an exemplary embodiment, angle “β” is less than angle “α” such that the force required for alignment member removal is greater than the force required for alignment member insertion. This facilitates ease of assembly, but removal requires a purposeful force (i.e., forces larger than experienced during typical vehicle use). Further, a distance “d” from alignment member outer wall 103 to a vertex 130 of retention member 120 is variably designed depending on various factors such as material composition and desired entry/removal force produced by retention member 120. For example, “d” may be shorter if retention member 120 is fabricated from a stiff material than if member 120 is fabricated from a compliant material. As such, the intersection between outer wall 103 and each of insertion face 126 and retention face 128 may have any suitable location along outer wall 103 between alignment member proximal end 110 and distal end 112.

As shown in FIGS. 1-3, alignment member 102 includes two opposed retention members 120. However, alignment member 102 may include any number of retention members 120 that enables system 10 to function as described herein. Moreover, retention members 120 may be positioned in any desired location along outer wall 103 between proximal end 110 and distal end 112, or may comprise the entire length of outer wall 103 therebetween.

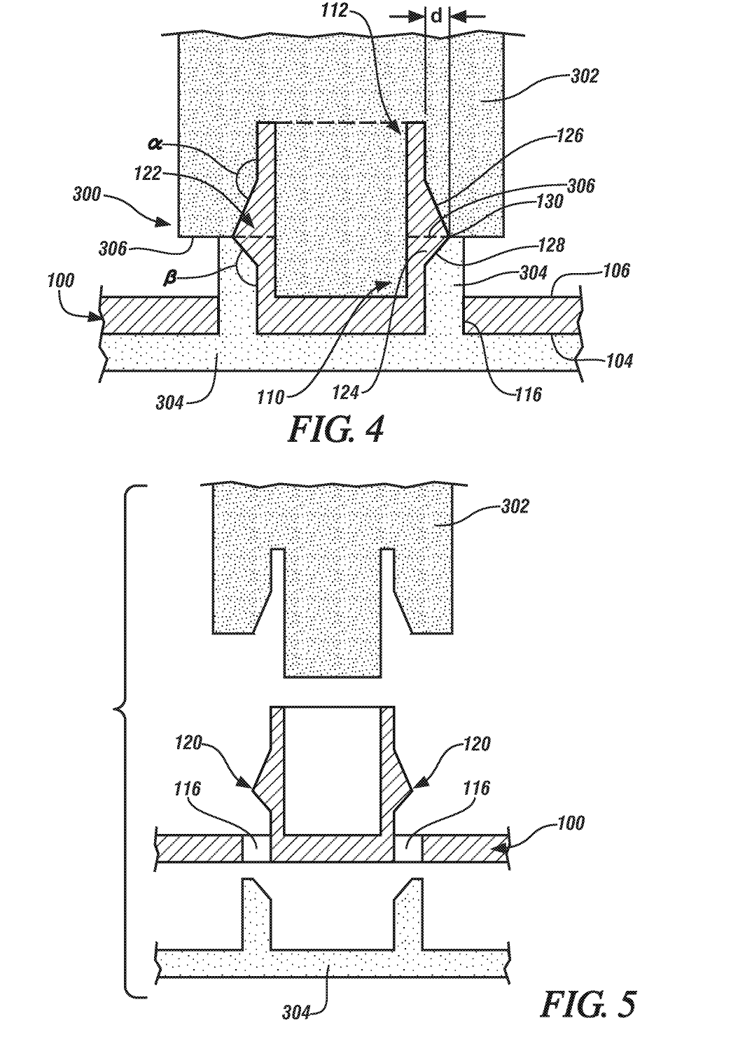

FIGS. 4 and 5 illustrate an exemplary mold assembly 300 used to form alignment member 102 and retention member 120. FIG. 4 illustrates a position of mold assembly 300 after first component 100 has been formed therein, and FIG. 5 illustrates a position of mold assembly 300 parted to remove the formed first component 100 therefrom. Mold assembly 300 includes an upper portion 302 and a lower portion 304 that come together in a closed position to define a mold parting line 306. In an exemplary embodiment, parting line 306 is advantageously oriented at retention member vertex 130 such that no action is needed in the tool (i.e., no side or transverse movement of portions of mold assembly 300).

While FIGS. 1-3 depict a single elastically deformable alignment member 102 in a corresponding circular aperture 204 to provide four-way alignment of the first component 100 relative to the second component 200, it will be appreciated that the scope of the invention is not so limited and encompasses other quantities and types of elastically deformable alignment elements used in conjunction with the elastically deformable alignment member 102 and corresponding circular aperture 204.

Standoffs 114 may be spaced relative to the outer diameter of alignment aperture 204 such that they provide a support platform at a height “h” above first component inner face 106 upon which second component inner face 208 rests when elastically deformable alignment member 102 is configured and disposed to interferingly, deformably and matingly engage alignment aperture 204 (best seen with reference to FIGS. 1 and 2). Stated alternatively, standoffs 114 are disposed and configured to provide a point of engagement between alignment aperture 204 and elastically deformable alignment element 102 at an elevation “h” above the base, inner face 106, of elastically deformable alignment member 102. While FIGS. 1 and 2 depict standoffs 114 in the form of posts at a height “h” relative to first component inner face 106, it will be appreciated that the scope of the invention is not so limited and also encompasses other numbers and shapes of standoffs 114 suitable for a purpose disclosed herein, and also encompasses a standoff in the form of a continuous ring disposed around alignment member 102. All such alternative standoff arrangements are contemplated and considered within the scope of the invention disclosed herein. Moreover, while FIG. 1 depicts standoffs 114 integrally formed on inner face 106, it will be appreciated that a similar function may be achieved by integrally forming standoffs 114 on second component inner face 208, which is herein contemplated and considered to be within the scope of the invention disclosed herein. Alternatively, system 10 may not include standoffs as illustrated in FIG. 3.

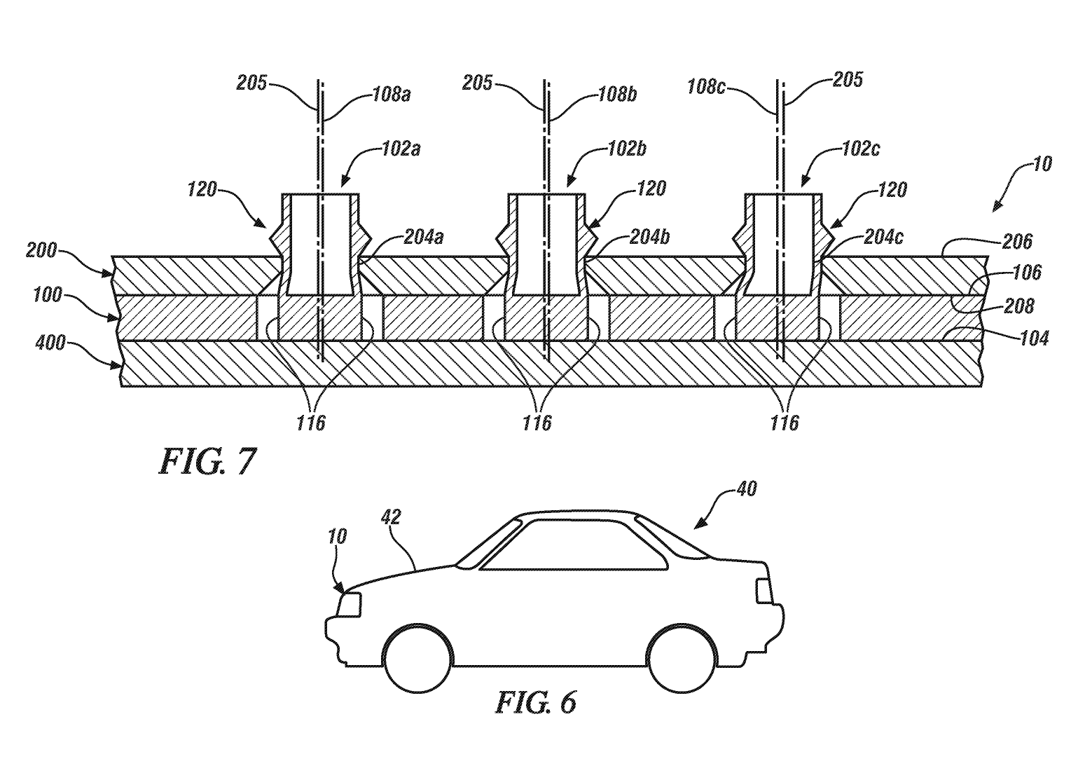

In view of the foregoing, and with reference now to FIGS. 6 and 7, it will be appreciated that an embodiment of the invention also includes a vehicle 40 having a body 42 with an elastically averaging alignment system 10 as herein disclosed integrally arranged with the body 42. In the embodiment of FIGS. 6 and 7, the elastically averaging alignment system 10 is depicted forming at least a portion of a front grill 400 of the vehicle 40. However, it is contemplated that an elastically averaging alignment system 10 as herein disclosed may be utilized with other structural features of the vehicle 40, such as interior trim and non-visible components like electrical module housings, instrument panel retainers, and console structure.

FIG. 7 illustrates an exemplary illustration of elastically averaged alignment system 10 for the coupling between body 42 and front grill 400 that is shown in FIG. 6. As shown, a plurality of alignment members 102a, 102b, and 102c are inserted into a plurality of corresponding alignment apertures 204a, 204b, 204c. Elastically deformable alignment members 102a, 102b, and 102c facilitate elastic averaging over the total of alignment members 102 to facilitate substantially aligning centerlines 108a, 108b, and 108c with a centerline 205 of corresponding alignment aperture 204, and leading to an improved coupling between first component 100 and second component 200. Due, for example, to the manufacturing tolerance and variance of oversized alignment apertures 204a-c, apertures 204a-c may be formed in a location other than the designed location. Alignment members 102a-c elastically deform within respective alignment apertures 204a-c to facilitate bringing centerlines 108a-c more in-line with centerlines 205 of respective alignment apertures 204a-c. As shown in the exemplary implementation, alignment members 102a, 102b deform generally to the left while alignment member 102c deforms generally to the right. Accordingly, because of manufacturing tolerances/variations, alignment members 102a, 102b, and 102c elastically average out the misalignment or positional error of the alignment features of first and second components 100, 200 to couple them in a desired orientation. In the exemplary embodiment, the deflection of each alignment member 102a and 102b is approximately half the deflection of alignment member 102c (i.e., the deflection of member 102c to the right is averaged between the opposed deflections of members 102a, 102b to the left).

An exemplary method of fabricating elastically averaged alignment system 10 includes forming first component 100 with at least one alignment member 102. Second component 200 is formed with chamfer 210 and inner wall 202 defining alignment aperture 204. At least one of alignment member 102 and alignment aperture 204 is formed to be elastically deformable such that when alignment member 102 is inserted into alignment aperture 204, at least one of alignment member 102 and inner wall 202 elastically deform to an elastically averaged final configuration to facilitate aligning first component 100 and second component 200 in a desired orientation.

Retention member 120 is formed on alignment member 102 to facilitate engagement and interference between alignment member 102 and second component 200. Alignment member 102 may be formed with a generally circular tubular body. Alternatively, or additionally, at least a portion of second component inner wall 202 may be formed from an elastically deformable material that expands during insertion of alignment member 102.

Systems and methods for retention of elastically averaged mating assemblies are described herein. The systems generally include a first component with an elastically deformable alignment member positioned for insertion into an alignment aperture of a second component. The mating of the first and second components is elastically averaged over each pair of corresponding alignment member and alignment aperture to precisely mate the components in a desired orientation. Moreover, the systems include a retention member for self-retention of the alignment member within the alignment aperture. The retention member includes angled portions to interferingly engage the second component. Accordingly, the retention features facilitate preventing unintentional disassembly of elastically averaged mated components, tunable elastically averaged mating systems, and reducing or eliminating the need for fasteners to mate the components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member; and
a second component comprising an inner wall defining an alignment aperture, said alignment aperture configured to receive said alignment member to couple said first component and said second component,
wherein said alignment member comprises at least one retention member configured to engage said second component to facilitate retaining at least a portion of said alignment member within said alignment aperture, said alignment member being an elastically deformable material such that when said alignment member is inserted into said alignment aperture, said alignment member elastically deforms to an elastically averaged final configuration to facilitate aligning and stiffening said first component and said second component in a desired orientation.

2. The alignment system of claim 1, wherein said alignment member comprises a pair of opposed retention members.

3. The alignment system of claim 1, wherein said at least one retention member comprises a first angled portion and a second angled portion.

4. The alignment system of claim 3, wherein said first angled portion defines an insertion face extending from said alignment member at a first angle, and said second angled portion defines a retention face extending from said alignment member at a second angle.

5. The alignment system of claim 4, wherein said second angle is greater than said first angle to facilitate easier insertion of said alignment member into said alignment aperture than removal thereof.

6. The alignment system of claim 1, wherein said alignment member is tubular.

7. A vehicle comprising:
a body; and
an elastically averaged alignment system integrally arranged with said body, said elastically averaged alignment system comprising:
a first component comprising an alignment member; and
a second component comprising an inner wall defining an alignment aperture, said alignment aperture configured to receive said alignment member to couple said first component and said second component,
wherein said alignment member comprises at least one retention member configured to engage said second component to facilitate retaining at least a portion of said alignment member within said alignment aperture, said alignment member being an elastically deformable material such that when said alignment member is inserted into said alignment aperture, said alignment member elastically deforms to an elastically averaged final configuration to facilitate aligning said first component and said second component in a desired orientation.

8. The vehicle of claim 7, wherein said alignment member comprises a pair of opposed retention members.

9. The vehicle of claim 7, wherein said at least one retention member comprises a first angled portion and a second angled portion.

10. The vehicle of claim 9, wherein said first angled portion defines an insertion face extending from said alignment member at a first angle, and said second angled portion defines a retention face extending from said alignment member at a second angle.

11. The vehicle of claim 10, wherein said second angle is greater than said first angle to facilitate easier insertion of said alignment member into said alignment aperture than removal thereof.

12. The vehicle of claim 1, wherein said alignment member is tubular.

13. A method of manufacturing an elastically averaged alignment system, said method comprising:
forming a first component comprising an alignment member;
forming a second component comprising an inner wall defining an alignment aperture configured to receive the alignment member to couple the first and second components; and
forming at least one retention member on the alignment member configured to engage the second component to facilitate retaining at least a portion of the alignment member within the alignment aperture,
wherein the first component is an elastically deformable material such that when the alignment member is inserted into the alignment aperture, the alignment member elastically deforms to an elastically averaged final configuration to facilitate aligning the first component and the second component in a desired orientation.

14. The method of claim 13, wherein said forming at least one retention member comprises forming a pair of opposed retention members.

15. The method of claim 13, further comprising forming the at least one retention member with a first angled portion and a second angled portion.

16. The method of claim 15, wherein said first angled portion defines an insertion face extending from the alignment member at a first angle, and the second angled portion defines a retention face extending from the alignment member at a second angle.

17. The method of claim 16, further comprising forming the second angle greater than the first angle to facilitate easier insertion of the alignment member into the alignment aperture than removal thereof.

18. The method of claim 13, wherein the alignment member and the at least one retention member are formed using a mold having a parting line oriented at the intersection of the first angled portion and the second angled portion when the mold is in a closed position.

19. The alignment system of claim 1, wherein said first component further comprises a pair of opposed tool clearance apertures.

20. The method of claim 13, wherein forming the first component further comprises forming the first component in a mold assembly with no action in the mold assembly.
